(19) United States
(12) Patent Application Publication
(10) Pub. No.: US 2022/0335106 A1
(43) Pub. Date: Oct. 20, 2022

(54) CLOUD-NATIVE CONTENT MANAGEMENT SYSTEM

(71) Applicant: Copyright Clearance Center, Inc., Danvers, MA (US)

(72) Inventors: Haralambos Marmanis, Waltham, MA (US); Simon Hutchinson, Meols (GB); Rich Hart, Buckhurst Hill (GB); Tom Morris, Petersfield (GB); Stuart Leyland-Cole, London (GB)

(21) Appl. No.: 17/722,085

(22) Filed: Apr. 15, 2022

Related U.S. Application Data
(60) Provisional application No. 63/175,113, filed on Apr. 15, 2021.

(51) Int. Cl. G06F 21/10

(52) U.S. Cl. CPC G06F 21/10; G06F 2221/0713

(57) ABSTRACT

A cloud-native content management system includes a content file system for storing digital content to be accessed via the Internet using a compute device. The system includes an authentication and authorization service that applies rules of granular access controls among a group of specified individuals. Using a token-based, temporary access process, authorized individuals are provided direct access to selected digital content in order to bypass time-restriction limitations that traditionally prevent the streaming of large data files. The system is additionally designed to support the interactive, online editing of stored software models by authorized users. As part of the modeling process, model change requests are submitted by authorized individuals using user-intuitive, domain-specific language. Thereafter, the software model is temporarily locked while the change request is validated for correctness and compatibility. Utilizing a staged modeling approach ensures that the software model remains continuously active and allows for granular model versioning.

### CROSS-REFERENCE TO RELATED APPLICATIONS

The present invention claims the benefit under 35 U.S.C. 119(e) to U.S. Provisional Patent Application No. 63/175,113, which was filed on Apr. 15, 2021, in the names of Haralambos Marmanis et al., the disclosure of which is incorporated herein by reference.

### FIELD OF THE INVENTION

The present invention relates generally to the field of content management and, more particularly, to cloud-native content management systems.

### BACKGROUND OF THE INVENTION

Across a wide variety of different academic and professional settings, individuals routinely work in a collaborative fashion to create, share, revise, and publish digital content. The types of digital content typically distributed can vary considerably depending upon the intended application, but most often includes text-based documents, images, audio files, and video files. Through the electronic capture and sharing of digital content, more efficient collaboration is ultimately achieved.

A content management system is a network-based content services platform that is designed to handle the sharing of digital content. Due to the exponential increase of digital content intended for collaboration amongst selected individuals and teams within a group, content management platforms have been developed with greater sophistication in not only storing digital content but also managing such content. Notably, content management systems have been enhanced to, inter alia, facilitate the identification of pertinent content through the creation and storage of metadata, establish and enforce rules of access, assign roles and responsibilities, maintain and track workflow tasks, and retain timelines for selected content throughout its evolution.

In a traditional content management system, a selection of servers is utilized to host the content management platform. In this manner, the servers function as a central hub between the individual users within the workgroup and the content repository, with the servers maintaining and implementing the preestablished rules of content access, modification, and distribution.

A server-based content management system introduces a sizable infrastructure and services management requirement. In particular, if a selection of cloud servers is utilized to host the content management system, sizable server rental charges are typically incurred due to the substantial amount of data storage and processing required. Additionally, patching and maintenance of the servers is routinely required which, in turn, introduces further costs.

Accordingly, cloud-native content management systems have become increasingly prevalent in the field in order to overcome some of the aforementioned shortcomings associated with cloud-based, or server-based, content management systems. In a cloud-native, or serverless, content management system, no designated server is utilized to implement content management processes. Rather, a cloud-native developmental model enables developers to build and run software applications without having to manage designated servers. In this model, servers are abstracted away from application development. When a content management process is to be undertaken, the application code is accessed on any available, non-designated, server maintained at a cloud server hosting facility. In this capacity, it is to be understood that various content management processes may be implemented across a wide array of different servers within the hosting facility.

By restricting the use of cloud servers to a limited number of operations, cloud server costs can be significantly reduced. For instance, instead of paying for the rental of a set of servers for a period of time as part of a subscription-based model, a consumption-based model can be employed that restricts costs based on usage (i.e., pay-as-you-go), thereby significantly reducing operational costs. Additionally, a consumption-based model eliminates the need for routine server updating and maintenance.

A cloud-native content management approach also affords greater scalability. Notably, as greater content management needs arise, additional software applications can be developed and seamlessly integrated into the content management platform by simply increasing, and commensurately paying for, cloud server consumption.

Although well-known in the art, conventional cloud-native content management systems have been found to suffer from a notable shortcoming which will be explained in detail below. Referring now to FIG. 1, the simplified architecture of a conventional cloud-native content management system is shown, the system being identified generally by reference numeral 11. As can be seen, system 11 is designed to be accessed by a user compute device, or client, 13 via the internet 15.

In the present example, cloud-native content management system 11 is shown implemented using an Amazon Web Services (AWS) cloud computing services platform, thereby allowing for an optimized selection and configuration of web services tools. As can be appreciated, the use of an AWS-based cloud computing services platform is provided for illustrative purposes only and system 11 could be similarly implemented using alternative cloud computing services platforms, such as the Microsoft Azure cloud computing services platform.

As can be seen, system 11 is configured with, inter alia, (i) a content file system 21, shown implemented herein using AWS Simple Storage Service (S3) 23, for maintaining all digital content generated by the user workgroup in a simple cloud storage device, and (ii) content management business logic services 31, which are designed with customized rules for handling the real-time exchange of information between an application programming interface (API) user gateway 33 and content file system 21.

Content management business logic services 31 are additionally configured with a service layer processing service 41 for, among other things, regulating all content transfer activities between content file system 21 and API gateway 33, including any proxying of the content stream. As can be appreciated, service layer processing service 41 is a serverless processing service which is designed to perform a custom, user-specified task without directly provisioning or managing specific servers (i.e., function-as-a-service). For illustrative purposes, processing service 41 is represented herein as being implemented using the AWS Lambda processing service.

In use, system 11 is designed to transfer content between client 13 and content file system 21 in the following manner. Namely, as the first step in the content transfer process, client 13 sends a content download request via API gateway 33, as represented generally by arrow 1. In turn, API gateway 33 ensures that client 13 is authorized to access the content. If authorized, the content request is received and processed by service layer processing service 41, as represented generally by arrow 2. Namely, service 41 identifies the content, ensures access can be granted, and locates the content file within content file system 21.

Thereafter, service layer processing service 41 accesses content file system 21 and requests the designated content file, as represented generally by arrow 3. In response, content file system 21 returns the content file to service layer processing service 41, as represented generally by arrow 4. In the final step, service layer processing service 41 delivers the designated file to client 13 via API gateway 33, as represented generally by arrow 5.

Accordingly, in conventional serverless content management system 11, service layer processing service 41 functions as an intermediary for all content streamed between client 13 and simple storage service 23. Applicant has uniquely recognized that content management systems designed in this fashion suffer from a couple notable shortcomings.

As a first shortcoming, conventional web-based processing services (e.g., processing service 41) are typically implemented with a time restriction limit in order to maximize widespread server availability. This shortcoming is particularly prevalent in modern function-as-a-service serverless infrastructures. As a result, it has been found that large files (e.g., video files) are often incapable of being streamed to client 13 using cloud-native content management system 11 for failing to complete file transmission within the designated time limit.

As a second shortcoming, conventional web-based processing services (e.g., processing service 41) are typically designed to operate on a consumption-based model (i.e., pay-as-you-go basis). Accordingly, for collaboration environments requiring the frequent transfer of relatively large files to and from a content file system, a consumption-based model often results in considerably high operations costs, which is highly undesirable.

### SUMMARY OF THE INVENTION

In view thereof, it is an object of the present invention to provide a cloud-native content management system for storing and sharing digital content.

It is another object of the present invention to provide a cloud-native content management system of the type as described above which is uniquely designed to regulate the modification and dissemination of stored digital content among a designated group of individuals.

It is yet another object of the present invention to provide a cloud-native content management system of the type as described above which establishes and enforces rules of granular access control among the designated group of individuals.

It is still another object of the present invention to provide a cloud-native content management system of the type as described above which provides designated individuals with adequate time to stream relatively large data files.

It is yet still another object of the present invention to provide a cloud-native content management system of the type as described above which has limited operational costs and is readily scalable.

It is yet another object of the present invention to provide a cloud-native content management system of the type as described above which allows for digital content to be requested and compiled using domain-specific language.

Accordingly, as one feature of the present invention, there is provided a cloud-native content management system for electronically storing digital content, the content management system being electronically accessible via the internet using a compute device, the content management system comprising (a) a content file system for storing the digital content, (b) content management business logic services for regulating the exchange of digital content between the content file system and the compute device, and (c) an authentication and authorization service in communication with the content management business logic services, the authentication and authorization service applying a set of access rules for the digital content, (d) wherein the authentication and authorization service selectively enables the compute device to directly communicate and exchange digital content with the content file system.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a simplified system diagram of the architecture for a prior art cloud-native content management system which is useful in understanding the traditional approach for downloading content files;

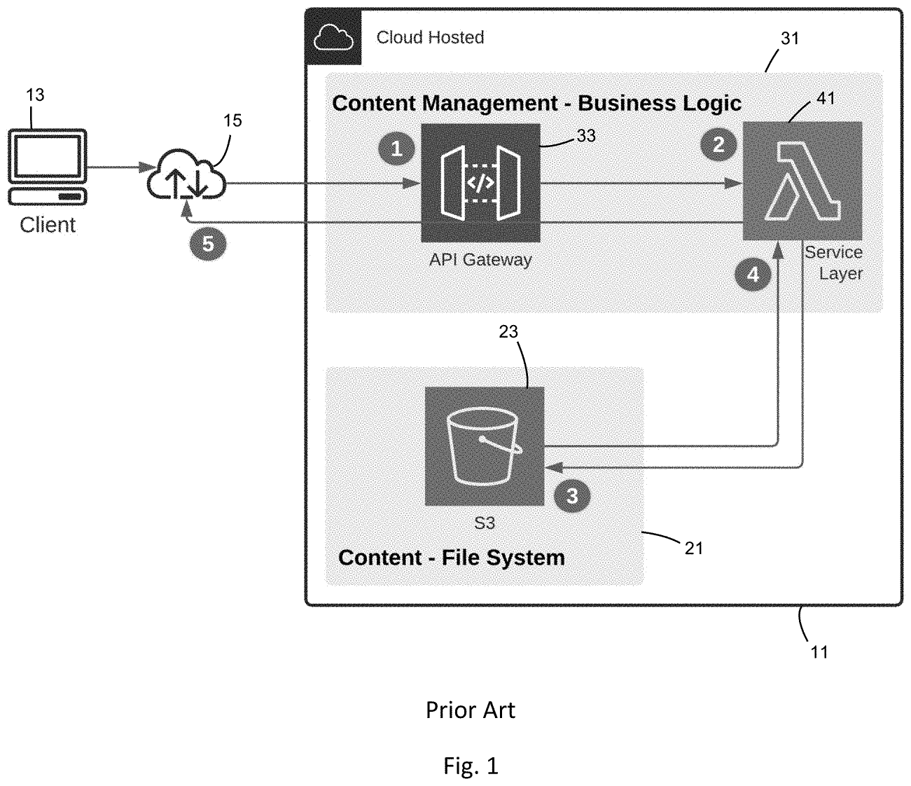

FIG. 2 is the basic architecture of a cloud-native content management system designed according to the teachings of the present invention;

FIG. 3 is the basic architecture of the cloud-native content management system of FIG. 2, the architecture being used to illustrate a novel approach for downloading content files; and

FIG. 4 is a flow of events depicting a novel process for executing a data model change using the cloud-native content management system of FIG. 2; and

FIG. 5 is a screen display of a sample content model change request submitted as part of the process depicted in FIG. 4.

### DETAILED DESCRIPTION OF THE INVENTION

### Cloud-Native Content Management System 111

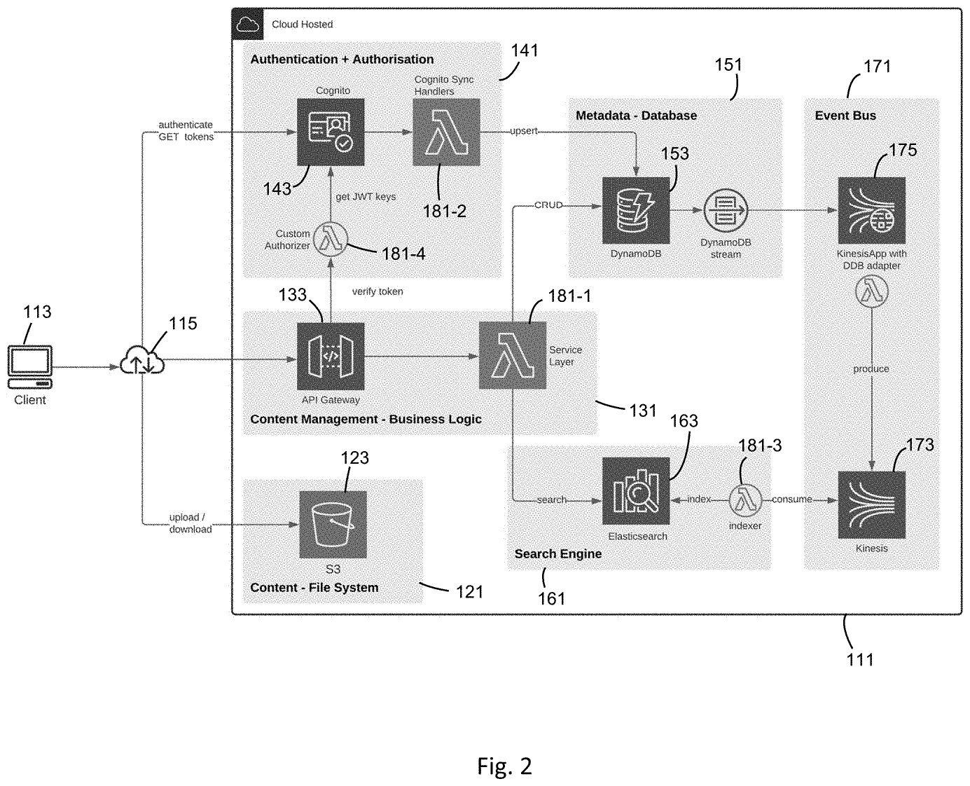

Referring now to FIG. 2, there is shown the basic architecture a cloud-native content management system designed according to the teachings of the present invention, the content management system being identified generally by reference numeral 111. As will be explained in detail below, system 111 is a network-based platform which is designed to store digital content and regulate the modification and dissemination of such content among a designated group of individuals. As a feature of the present invention, system 111 is uniquely configured to provide users with secure, credentialed access to its digital content with adequate duration to stream relatively large data files.

As defined herein, use of the term “digital content” represents any type of electronic data, or work, which is stored on digital media and includes, inter alia, text-based documents, images, audio files, and video files.

In the description that follows, cloud-native content management system 111 is shown implemented using an Amazon Web Services (AWS) cloud computing services platform, thereby allowing for an optimized selection and configuration of web services tools. However, is should be known that the use of an AWS-based cloud computing services platform is provided for illustrative purposes only and system 111 could be similarly implemented using alternative cloud computing services platforms, such as the Microsoft Azure cloud computing services platform, without departing from the spirit of the present invention.

As can be seen, system 111 is designed to be accessed by a user compute device, or client, 113 via the internet 115. System 111 is preferably configured with (i) a content file system 121, shown implemented herein using AWS Simple Storage Service (S3) 123, for maintaining all digital content generated by the user workgroup in a simple cloud storage device, (ii) content management business logic services 131, which are designed with customized rules for handling the real-time exchange of information between an application programming interface (API) user gateway 133 and content-management databases, (iii) authentication and authorization service 141, shown implemented herein using AWS Cognito authentication service 143, for providing identification (ID) management and security to ensure proper authorization for system services and content, (iv) metadata database service 151, shown implemented herein using AWS DynamoDB key-value and document service 153, for processing digital content (e.g., parsing, applying metadata, categorizing, and the like) and storing such data, (v) a search engine 161, shown implemented herein using AWS Elasticsearch service 163, for facilitating the identification of digital content (e.g., using metadata stored in database service 151), and (vi) an event bus 171, shown implemented herein using AWS Kinesis data-streaming service 173 and AWS Kinesis with DDB adapter data-streaming service 175, for the real-time data streaming of content to client 113.

System 111 is additionally configured with several serverless processing services 181, each of which is designed to perform a custom, user-specified task without directly provisioning or managing specific servers (i.e., function-as-a-service). For illustrative purposes only, processing, or compute, services 181 are represented herein as being implemented using the AWS Lambda processing service.

As seen in FIG. 2, system 111 comprises (i) a service layer processing service 181-1 for controlling and integrating operations between various system services, (ii) a sync handler processing service 181-2 for synchronizing application user-data across multiple user devices, (iii) an indexing processing service 181-3 for indexing metadata and documents between AWS Elasticsearch service 163 and event bus 171, and (iv) a custom authorizer service 181-4 for implementing a custom authorization scheme that uses a token authentication strategy to provide temporary access to documents stored in content file system 121.

As will be explained further in detail below, the inclusion of custom authorizer service 181-4 enables system 111 to bypass all serverless processing services 181 during the upload and download of content between user 113 and content file system 121. As a result, system 111 is able to overcome time restrictions and other related shortcomings associated with conventional cloud-native content management systems, and therefore serves as a principal novel feature of the present invention.

### Content Transfer Process

As referenced above, system 111 is uniquely designed to provide user 113 with direct access to content within simple cloud storage device 123 by implementing a token-based, temporary access process in order to bypass time-restriction limitations that prevent the streaming of large files in conventional systems.

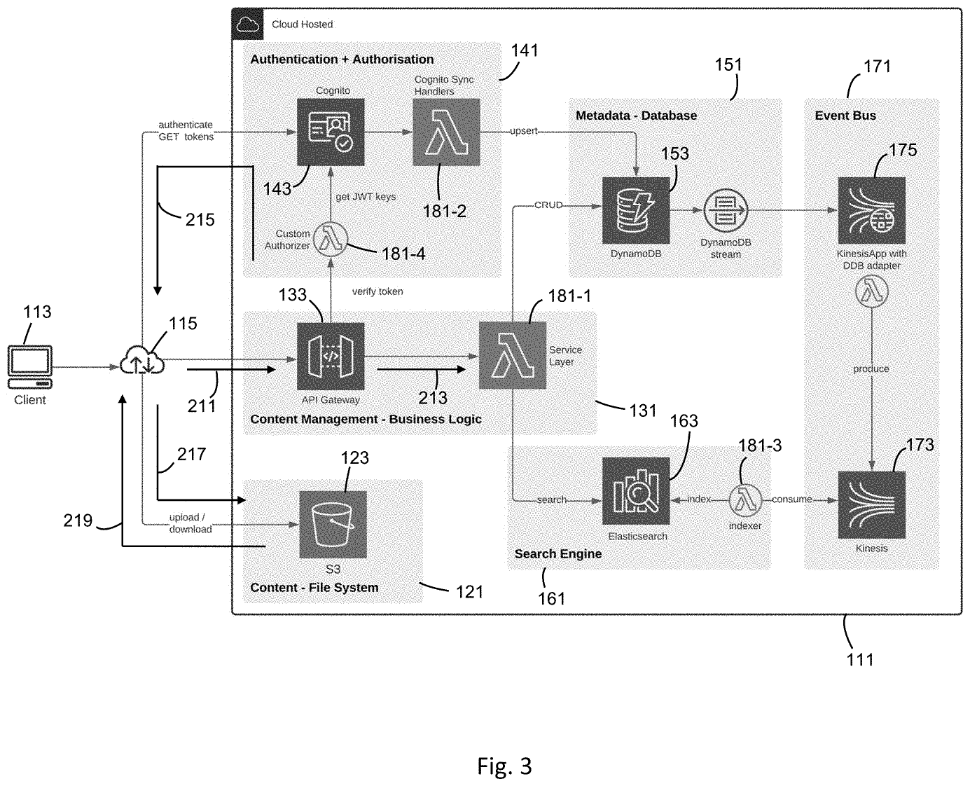

Specifically, in FIG. 3, cloud-native content management system 111 is shown modified to illustrate the novel approach for transferring content files directly between client 113 and content file system 121 in order to avoid the incurrence of time restrictions and/or excessive use costs. As the first step of the novel process, client 113 sends a content download request via API gateway 133, as represented generally by arrow 211. In turn, API gateway 133 communicates with authentication and authorization services 141 to ensure that client 113 is authorized to access the content.

As a feature of the present invention, authentication and authorization service 141 is in direct communication with metadata database service 151. Accordingly, through update operations handled by processing service 181-2, detailed user access controls can be established and maintained as metadata in metadata database service 151. As a result, rules of granular access control among a group of individuals can be enforced by content management system 111, thereby precisely detailing the extent of access and control afforded to each individual with respect to stored content.

If client 113 is authorized to access the content, the content request is received and processed by service layer processing service 181-1, as represented generally by arrow 213. Namely, service 181-1 identifies the content, ensures access can be granted, and locates the content file within content file system 121.

Thereafter, service layer processing service 181-1 instructs custom authorizer service 181-4 to implement a temporary credential routine to obtain a JSON web token (JWT) key from a security token service (STS). The JWT key, or access token, is restricted to the designated content and is delivered to client 113 via authentication and authorization service 141, as represented generally by arrow 215.

Accordingly, using the access token, client 113 initiates a second content download request directly with content file system 121, as represented generally by arrow 217. It is to be understood that, to ensure optimal security, the temporary access token only provides authorization and access to the designated content in content file system 121. In response to the request set forth in step 217, a stream of restricted content is directly transferred from simple cloud storage device 123 to client 113, as represented generally by arrow 219.

Although the above-described example details the download of content from simple cloud storage device 123 to client 113, it is to be understood a similar process could be implemented to upload content from client 113 to simple cloud storage device 123.

Enabling client 113 to directly stream content to and/or from content file system 121 thereby eliminates time-restriction parameters and processing costs inherent in processing services 181, which is a principal object of the present invention. Furthermore, by providing access credentials that are both temporary and content restrictive, proper security for content file system 121 is maintained.

As detailed above, the unique architecture of content management system 111 enables users 113 to directly access content within simple cloud storage device 123 by implementing a token-based, temporary access process. However, it should be noted that the unique architecture of content management system 111 enables a number of additional features to be readily implemented.

In particular, by providing user 113 with direct access to content file system 121 as well as authentication and authorization service 141, all data management processes need not be executed through a single service layer (e.g., service layer 41) within content management business logic services (e.g., services 31). Furthermore, system 111 allows for a selection of customizable, task-specific, web-services tools to be seamlessly integrated into the system architecture in order to support a wide array of enhanced capabilities.

For instance, the inclusion of metadata database service 151 enables content management system 111 to dynamically maintain an abundance of metadata. By associating an increased amount of metadata with the content, the data model is afforded with a wide scope of potential applications.

### Interactive Content Management Software Modeling

As a principal feature of the present invention, system 111 is uniquely designed to permit interactive, online editing of software models by authorized users. In this manner, user-specified data can be requested and compiled in a specialized fashion relative to the particular domain application. As such, system 111 is effectively able to support domain-specific language (DSL).

More particularly, the unique architecture of system 111 supports a flexible content model with a high-level, semantic-based database description and structuring formalism. In other words, detailed attributes of digital content (e.g., types, properties, relationships) can be easily maintained and modified via system 111 in order to create an optimal data model. This enhanced flexibility in managing digital content allows for data modeling in any business domain with precision and agility.

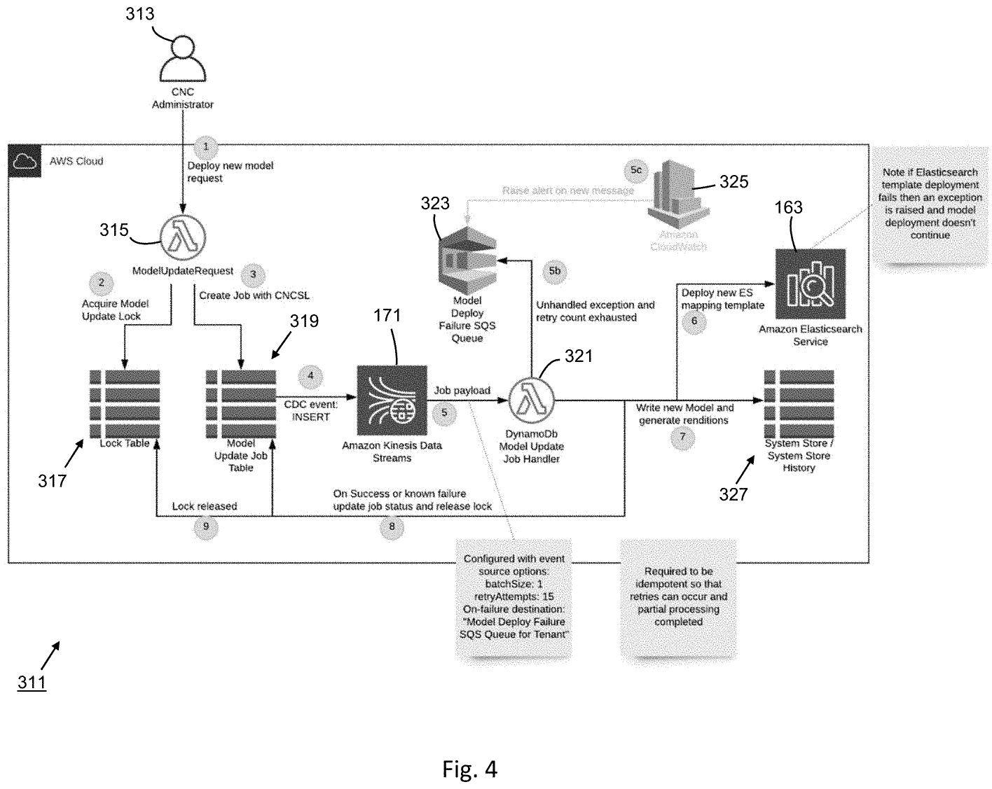

As noted above, system 111 is uniquely designed to support data model changes in a simple, user-friendly fashion. For ease of understanding, an illustrative implementation of a data model change executed via system 111 is set forth in detail below. Specifically, in FIG. 4, there is shown a novel process for executing a data model change using the basic architecture of cloud-native content management system 111, the process being represented generally by reference numeral 311. As can be seen, in the first step of process 311, an authorized individual, or user, 313 (e.g., a data model administrator) electronically interfaces with content management system 111 (e.g., through API Gateway 133) and deploys a request to change a specified data model.

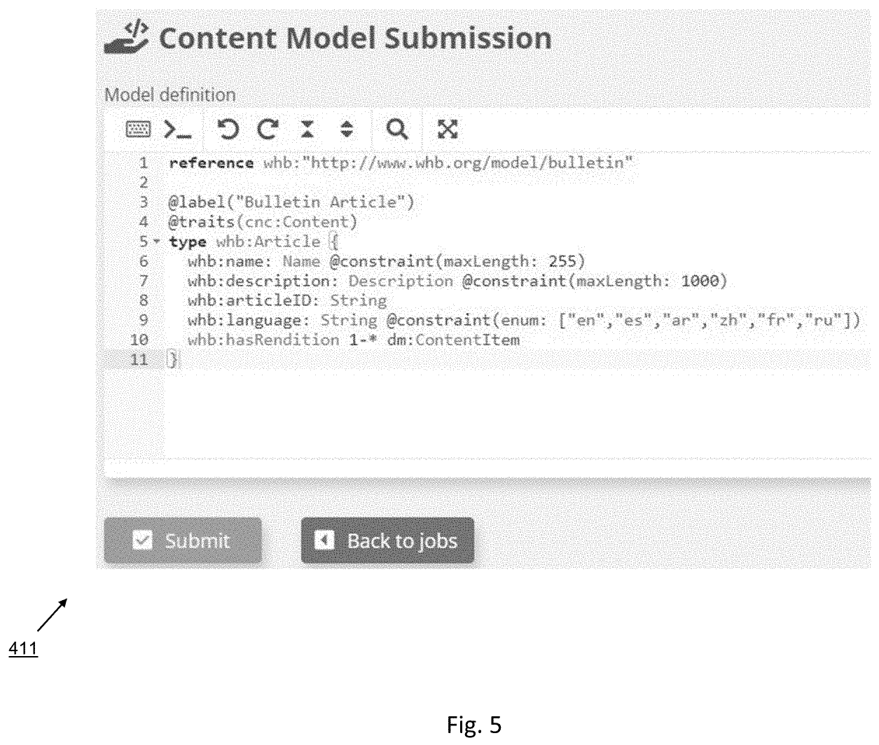

In FIG. 5, a screen display of a sample content model change request is shown, the screen display being represented generally by reference numeral 411. As a principal feature of the present invention, interactive modeling is accomplished using a simple, user-intuitive UI webpage of the type shown herein. As can be seen, the webpage is designed so that content model change requests can be submitted using concise, terse, and minimal language. Furthermore, it should be noted that change requests can be submitted as (i) fragmentary changes, either a single type (as shown herein) or several types at a time, or (ii) for all the types that make up the entire model. Adopting a format-specific domain language, as well as the accompanying parser generator grammar that defines the rules of that language, improves the authoring experience and enables changes to be rendered by non-technical staff.

Referring back to FIG. 4, a processing service 315, which is customized to handle model change requests, temporarily locks the model while the change request is being processed, as represented by reference numeral 317. All model change requests temporarily lock the data model to ensure no conflicting submissions cause corruption or consistency issues.

Thereafter, service 315 creates and stores a model-change job 319, which details the specific updates to be implemented in the designated data model. Model-change job 319 is then inserted as an event with event bus 171 so that this activity can be handled by the appropriate down-stream components for asynchronous processing.

A custom-designed, job-handling process service 321 receives model-change job 319 and validates the proposed data model change for correctness. In the present implementation, a message queuing service 323 and monitoring platform 325 are utilized to perform the validation process for the proposed data model change.

During the validation, or staging, process, the model change submission is validated for correctness and compatibility with the currently deployed (i.e., active) model. As part of the staging process, user 313 may receive compatibility notifications with options on how to proceed. For example, a change request that is normally validated but is reported as incompatible (e.g., a change of a property from non-mandatory to mandatory) may enable user 313 to bypass the notification and proceed with the model change.

Once validated, service 321 deploys a new mapping template for model-change job 319 to search engine service 163. As a result, search queries can be properly mapped for the model changes included in job 319. Thereafter, service 321 constructs a new data model 327, which includes the proposed modifications set forth in model-change job 319, into content management system 111. Once the status of the update is deemed successful, the lock on the data model is released.

To summarize, the unique architecture of content management system 111 enables various users, with granular access controls, to dynamically add, delete, or modify metadata associated with each content item. As a result, a comprehensive amount of metadata can be associated with stored content in order to enhance the data model.

Furthermore, the specific manner in which data modeling process 311 handles content change submissions provides a number of unique advantages over conventional content management systems.

As a first advantage, process 311 enables data modeling changes to be implemented safely and easily by authorized individuals. Notably, utilizing a staged approach for proposed data model changes (i) ensures that the data model remains active at all times and does not require a system restart, (ii) provides compatibility checks which inform users of the impact of proposed changes before completion, and (iii) enables patch-type data updates to be readily integrated into the data model.

As a second advantage, process 311 enables data modeling changes to be simply and easily implemented, even by a non-technical user. As previously referenced, the webpage utilized to submit model changes is designed using concise, user-friendly language that facilitates the process for creating a change request.

As a third advantage, process 311 supports data modeling with semantic precision. As a result, data models can be constructed for interoperability across various systems and organizations. For instance, multiple model roots are permissible. Instead of requiring a data model to inherit an existing system-provided type, any model or ontology can be utilized.

As a fourth advantage, process 311 supports model versioning wherein every change to the model creates a new numerically labeled version of the whole model as a snapshot in time. Through granular versioning, the difference between model changes can be inspected and traced. As a result, even if an old content-data item is found to be incompatible with the currently deployed model, the item can still be validated against a traceable referenced model schema.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A cloud-native content management system for electronically storing digital content, the content management system being electronically accessible via the Internet using a compute device, the content management system comprising:
(a) a content file system for storing the digital content;
(b) content management business logic services for regulating the exchange of digital content between the content file system and the compute device; and
(c) an authentication and authorization service in communication with the content management business logic services, the authentication and authorization service applying a set of access rules for the digital content;
(d) wherein the authentication and authorization service selectively enables the compute device to directly communicate and exchange digital content with the content file system.

2. The content management system as claimed in claim 1 wherein the authentication and authorization service restricts the direct exchange of digital content between the content file system and the compute device based on the set of access rules.

3. The content management system as claimed in claim 2 wherein the authentication and authorization service issues an access token to the compute device that provides temporary access to a selection of the digital content stored in the content file system.

4. The content management system as claimed in claim 3 further comprising a metadata database service in communication with the content management business logic services, the metadata database service maintaining metadata to be associated with the digital content.

5. The content management system as claimed in claim 4 wherein the metadata database service is in direct communication with the authentication and authorization service.

6. The content management system as claimed in claim 5 wherein the metadata database service maintains the set of access rules applied by the authentication and authorization service.

7. The content management system as claimed in claim 6 further comprising a search engine for facilitating identification of the digital content stored in the content file system.

8. The content management system as claimed in claim 7 further comprising an event bus for real-time data streaming of digital content to the compute device.

9. The content management system as claimed in claim 3 wherein the content file system is adapted to store a first version of a software model which can be selectively accessed and edited by the compute device in compliance with the set of stored access rules.

10. The content management system as claimed in claim 9 further comprising a model update request service for receiving an electronic change request for the first version of the software model.

11. The content management system as claimed in claim 10 wherein the change request is submitted electronically from the compute device using domain-specific language.

12. The content management system as claimed in claim 11 wherein the update model request service temporarily locks the first version of the software model upon receiving the electronic change request.

13. The content management system as claimed in claim 12 further comprising a job-handing process service for validating the change request for correctness and compatibility with the first version of the software model.

14. The content management system as claimed in claim 13 wherein the job-handling process service constructs a second version of the software model which incorporates the change request.

15. The content management system as claimed in claim 14 wherein the second version of the software model is unlocked for selective access and editing in compliance with the set of stored access rules.
